(19) United States
(12) Patent Application Publication
(10) Pub. No.: US 2026/0152404 A1
(43) Pub. Date: Jun. 4, 2026

(54) Synthesis of Zeolite Nanosheets from Mining Waste

(71) Applicant: Aditya Newalkar, Mumbai (IN)

(72) Inventors: Aditya Newalkar, Mumbai (IN); Suresh B Deshmukh, Pune (IN)

(21) Appl. No.: 18/569,057

(22) PCT Filed: Jun. 13, 2022
(86) PCT No.: PCT/IN2022/050543

§ 371 Date: Dec. 11, 2023

(30) Foreign Application Priority Data
Jun. 11, 2021 (IN) 202121021561

(51) Int. Cl. C01B 37/00; B01D 67/00; B01D 69/02; B01D 71/02

(52) U.S. Cl. CPC C01B 37/005; B01D 67/0051; B01D 69/02; B01D 71/0281; B01D 2323/081; B01D 2325/02831; B01D 2325/02832; B01D 2325/04

(57) ABSTRACT

The Synthesis of Zeolite nanosheets from mining waste without using any OSDA or chemical reagents during the secondary growth of zeolite nanosheets is disclosed. The produced Zeolite nanosheet may be a synthetic material.

### TECHNICAL FIELD

The present subject matter is related, in general, to the method of synthesis of zeolite, more specifically synthesis of Zeolite nanosheet from mining waste.

### BACKGROUND OF THE INVENTION

Zeolites are crystalline aluminosilicates comprising a uniform network of SiO2 and Al2O3 tetrahedra. This three dimensional network of tetrahedra in zeolites has uniform microporous channels. Zeolite particles having a size of a unit cell (e.g., 1-5 nm), with structural features of lamellar morphology, commonly referred to as membranes, are desirable for state-of-the-art devices for gas separation, catalysis, xylene isomer separation and low-dielectric constant materials.

In addition, the introduction of mesopores with similar size (e.g., Smaller than 5 nm) between the Zeolitic structural features enables catalysis for fast and selective reactions.

Zeolites can be synthesized from pure reactants, clays, natural zeolites and also from solid wastes such as ores, rocks and tailings.

Major constraints in synthesis of zeolite membranes have been the low flux and high cost, which make the required membrane area to be economically non-viable. Zeolites and Zeotype materials in a specific framework are required for Zeolite synthesis, i.e. materials that contain one, two, or three-dimensional open channels, whose dimension depends upon the size of the Zeolite molecules. This microporous structure may provide the basis for many of the aforementioned applications.

Naturally occurring inorganic materials are layered materials or conventional layered materials e.g., montmorillonite (natural clay) do not possess channel systems or open frameworks within the layers. The absence of channels and/or open frame materials limits their use in applications like catalysis, adsorption, and separation.

Extensive efforts have been devoted to exfoliate layered Silicates to make mesoporous materials, generally referred to as top-down approach of synthesizing Zeolites.

Zeolite membranes are usually synthesized by either of the two methods, direct method of primary growth on the support or a seeded secondary growth.

In both of these methods, the support (silica or ceramic) is dipped inside the zeolite growth precursors (source of alumina and silica, Organic Structure Directing Agents (OSDAs) and water) and then hydrothermally treated for the nucleation and growth of the zeolite crystals.

However, the existing methods are expensive and ineffective in arriving at the lamellar structure of zeolite material without use of OSDAs. Here Structure Directing Agent is Tetraethylammonium ions, and are very expensive.

Furthermore, since tetraethylammonium ions are entrapped in the crystals during synthesis of Zeolite, it is necessary to remove tetraethylammonium ions at this time, exhaust gas causes environmental contamination, and a large amount of chemicals is also required for a detoxifying treatment of the mother fluid of synthesis.

The conventional techniques comprise the steps of mixing silicate sources with precursors along with zeolite seeds for synthesizing zeolite materials.

Since the organic SDA is used, the method of synthesizing a zeolite becomes very expensive and also causes a large environmental load.

Until now, single MFI nanosheets have been prepared using a multi-step approach based on the exfoliation of layered MFI, followed by centrifugation to remove non-exfoliated particles.

Some prior art references Article “Synthesis of zeolite A using the waste of iron mine tailings dam and its application for industrial effluent treatment”, (Juliana de Carvalho Izidoro, Michelle Caroline Kim, Valentina Ferraraccio Bellelli, Mara Cristina Pane, Amilton Barbosa Botelho Junior, Denise Crocce Romano Espinosa, Jorge Alberto Soares Tenório, Synthesis of zeolite A using the waste of iron mine tailings dam and its application for industrial effluent treatment, Journal of Sustainable Mining, Volume 18, Issue 4, 2019, Pages 277-286, ISSN2300-3960, https://doi.org/10.1016/j.jsm.2019.11.001.), Article “Zeolite synthesis from Brazilian coal fly ash for removal of Zn2+ and Cd2+ from water” (Progress in Environmental Science and Engineering 10.4028/www.scientific.net/AMR.356-360).

Zeolite Synthesis from Brazilian Coal Fly Ash for Removal of Zn2+ and Cd2+ from Water 10.4028/www.scientific.net/AMR.356-360.1900, and US patent document.

U.S. Pat. No. 6,692,722B2 disclose synthesis of zeolite from mining wastes together with aqueous NaOH solution. However, the conventional synthesis methods adopted do not produce zeolite with high flux and high selectivity of molecules.

References “Progress in seed-assisted synthesis of zeolites without using organic structure-directing agents” (Kenta Iyoki, Keiji Itabashi, Tatsuya Okubo, Progress in seed-assisted synthesis of zeolites without using organic structure-directing agents, Microporous and Mesoporous Materials, Volume 189, 2014, Pages 22-30, ISSN 1387-1811, https://doi.org/10.1016/j.micromeso.2013.08.008.(https://www.sciencedirect.com/science/article/pii/S1387181113003843), and the US patent document US20190054420A1 discloses economical and OSDA-free synthesis of zeolites. However, the raw material sources are not derived from the mining wastes.

Furthermore, references are produced below for quick reference:
Mining Waste Valorization: Valorization of Bauxite Residue (red mud): in pursuit of a technologically realistic and financially viable process Yiannis Pontikes, Mineral Recycling Forum 2012.
Synergistic co-processing of an acidic hardwood derived pyrolysis bio-oil with alkaline red Mud bauxite mining waste as a sacrificial upgrading catalyst”, http://dx.doi.org/10.1016/j.apcatb.2013.02.007

### Zeolite Membranes

### Mesoporous Zeolites

U.S. Pat. No. 9,180,413 B2,
ONE-STEP SYNTHESIS OF MESOPOROUS PENTASIL ZEOLITE
WO Patent Number: WO2018064599A1
FORMING DIENES FROM CYCLIC ETHERS AND DIOLS, INCLUDING TETRAHYDROFURAN AND -METHYL-1,4-BUTANEDIOL
Ultra-selective high-flux membranes from directly synthesized zeolite nanosheets.
M. Y. Jeon, D. Kim, P. Kumar; et al.
Nature 2017 543 (7647), 690-694 doi:10.1038/nature 21421
Dispersible exfoliated zeolite nanosheets and their application as a selective membrane.
K. Varoon, X. Zhang, B. Elyassi; et al.
Science 2011 334(6052), 72-75 doi:10.1126/science.1208891
Grain boundary defect elimination in a zeolite membrane by rapid thermal processing.
J. Choi, H.-K. Jeong, M. A. Snyder; et al.
Science 2009 325 (5940), 590-593 doi:10.1126/science.1176095
Microstructural optimization of a zeolite membrane for organic vapor separation.
Z. P. Lai, G. Bonilla, I. Diaz; et al.
Science 2003 300 (5618), 456-460 doi:10.1126/science.1082169 Synthesis of self-pillared zeolite nanosheets by repetitive branching.
X. Zhang, D. Liu, D. Xu, M. Tsapatsis; et al.

### Mixed Matrix and Polymer Supported Membranes

### Process Design

Science 2012 336 (6089), 1684-1687 doi:10.1126/science.1221111
Hydrothermal synthesis of zeolites with three-dimensionally ordered mesoporous-imprinted structure.
H. Chen, J. Wydra, X. Zhang; et al.
JACS 2011 133 (32), 12390-12393 doi:10.1021/ja2046815
Hierarchical nanofabrication of microporous crystals with ordered mesoporosity.
W. Fan, M. A. Snyder, S. Kumar; et al.
Nature Materials 2008 7 (12), 984-991 doi:10.1038/nmat 2302
Layer structure preservation during swelling, pillaring and exfoliation of a zeolite precursor.
S. Maheshwari, E. Jordan, S. Kumar; et al.
JACS 2008 130 (4), 1507-1516 doi:10.1021/JA077711i
Open-pore two-dimensional MFI zeolite nanosheets for the fabrication of hydrocarbon
H. Zhang, Q. Xiao, X. Guo; et al.
Angew. Chem. Int. Ed. 2016 55 (25), 7184-7178 doi:10.1002/anie.201601135
A semi-empirical approach for predicting the performance of mixed matrix membranes
J. A. Sheffel, M. Tsapatsis
J. Membrane Sci. 2009 326 (2) 595-607 doi:10.1016/j. memsci.2008.10.041
Fabrication of polymer/selective-flake nanocomposite membranes and their use in gas
H. K. Jeong, W. Krych, H. Ramanan; et al.
Chem. Mater. 2004 16 (20) 3838-3845 doi:10.1021/cm049154u
A mathematical model for zeolite membrane module performance and its use for techno-economic evaluation of improved energy efficiency hybrid membrane-distillation processes for butane isomer separations.
N. Mittal, P. Bai, A. Kelloway; et al.
J. Membrane Sci. 2016 520, 434-339 doi:10.1016/j.memsci.2016.06.041
Modeling, optimization and cost analysis of an IGCC plant with a membrane reactor for carbon capture.
F. V. Lima, P. Daoutidis, M. Tsapatsis
AIChE 2016 62 (5), 1568-1580 doi:10.1002/aic.15153
Continuous production of 5-hydroxymethylfurfural from fructose: a design case study
A. I. Torres, P. Daoutidis, M. Tsapatsis
Energy Environ. Sci. 2010 3 (10), 1560-1572 doi:10.1039/C0EE00082E

### Adsorption

### Crystallography

### Catalysis

Identifying optimal zeolitic sorbents for sweetening of highly sour natural gas.
M. S. Shah, M. Tsapatsis, J. I. Siepmann
Angew. Chem. Int. Ed. 2106 55 (20), 6041-6046 doi:10.1002/ange.201600612
Discovery of optimal zeolites for challenging separations and chemical transformation.
P. Bai, M. Y. Jeon, L. Ren; et al.
Nature Comm. 2015 6, 5912 doi:10.1038/ncomms6912
Adsorption of fermentation inhibitors from lignocellulosic biomass hydrolyzates for improved ethanol yield and value-added product recovery.
R. Ranjan, S. Thust, C. Gounaris, E. Chrysanthos; et al.
Micropor. Mesopor. Mater. 2009 122 (1-3), 143-148 doi:10.1016/j. micromeso.2009.02.02
A titanosilicate molecular sieve with adjustable pores for size-selective adsorption of molecules.
S. M. Kuznicki, V. A. Bell, S. Nair; et al.
Nature 2001 412 (6848), 720-724 doi:10.1038/35089052
On the rotational intergrowth of hierarchical FAU/EMT zeolites.
M. Khaleel, A. J. Wagner, K. A. Mkhoyan; et al.
Angew. Chem. Int. Ed. 2014 53 (36), 9456-9461 doi:10.1002/anie.201402024
A highly crystalline layered silicate with three-dimensionally microporous layers.
H. K. Jeong, S. Nair, T. Vogt; et al.
Nature Mater. 2003 2 (1), 53-58 doi:10.1038/nmat795
A study of heat-treatment induced framework contraction in strontium-ETS-4 by powder neutron diffraction and vibrational spectroscopy.
S. Nair, M. Tsapatsis, B. H. Toby; et al.
JACS 2001 123 (51), 12781-12790 doi:10.1021/ja011703z
Synthesis and structure determination of ETS-4 single crystals.
S. Nair, H. K. Jeong, A. Chandrasekara
Chem. Mater. 2001 13 (11), 4247-4254 doi:10.1021/cm0103803
Self-pillared, single-unit-cell Sn-MFI zeolite nanosheets and their use of glucose and Lactose Isomerization.
L. Ren, Q. Guo, P. Kumar; et al.
Angew. Chem. Int. Ed. 2015 54 (37), 10848-10851 doi:10.1002/anie.201505334
One-pot synthesis of 5-(ethoxymethyl)furfural from glucose using Sn-BEA and Amberl Zeolite and Silica Nucleation and Growth Studies.

### Reviews

C. M. Lew, N. Rajabbeigi, M. Tsapatsis
Ind. Eng. Chem. Res. 2012 51 (14), 5364-5366 doi:10.1021/ie2025536
Influence of layer structure preservation on the catalytic properties of the pillared zeolite MCM-36.
S. Maheshwari, C. Martinez, M. T. Portilla; et al.
J. Catal. 2010 272 (2), 298-308 doi:10.1016/j.jcat.2010.04.011
Combining pre-and post-nucleation trajectories for the synthesis of high FAU-content.
M. Khaleel, W. Xu, D. A. Lesch; et al.
Chem. Mater. 2016 28 (12), 4202-4213 doi:10.1021/acs.chemmater.6b00588
Nanoparticles in lysine-silica sols.
T. M. davis, M. A. Snyder, J. E. Krohn; et al.
Chem. Mater. 2006 18 (25), 5814-5816 doi:10.1021/cm061982v
Mechanistic principles of nanoparticle evolution to zeolite crystals.
T. M. Davis, T. O. Drews, H. Ramanan; et al.
Nature Mater. 2006 5 (5), 400-408 doi:10.1038/nmat1636
Zeolite (MFI) crystal morphology control using organic structure-directing agents.
G. Bonilla, I. Diaz, M. Tsapatsis; et al.
Chem. Mater. 2004 16 (26), 5697-5705 doi:10.1021/cm048854w
Zeolite membranes-a review and comparison with MOFs.
N. Rangnekar, N. Mittal, B. Elyassi; et al.
Chem. Soc. Rev. 2015 44 (20), 7128-7154 doi:10.1039/C5CS00292C
Hierarchical nanomanufacturing: from shaped zeolite nanoparticles to high-performance separation membranes.
M. A. Snyder, M. Tsapatsis
Angew. Chem. Int. Ed. 2007 46 (40) 7560-7573 doi:10.1002/anie.200604910
Progress in manipulating zeolite morphology and related applications.
T. O. Drews, M. Tsapatsis
Curr. Opin. Colloid Interf. Sci. 2005 10 (5-6), 233-238 doi:10.1016/j.cocis.2005.09.013

The SDAs may be used to control Zeolite Nanosheet structure and morphology. This method is time-consuming, costly and low-yield and it produces fragmented nanosheets with submicrometric lateral dimensions. Hence, there has been a demand for a production method in which the end product has the same high flux and selectivity as the conventional process but uses no organic SDAs.

### SUMMARY OF THE INVENTION

The present invention discloses the Synthesis of Zeolite nanosheets from mining waste without using any OSDA or chemical reagents during the secondary growth of zeolite nanosheets. The produced Zeolite nanosheet may be a synthetic material.

The present invention utilizes direct (bottom-up) synthesis strategies for producing zeolites from mining waste. Bottom-up approach (direct synthesis) is attractive because the top-down approaches rely on multiple steps (hydrothermal treatment of a solution containing a silica/alumina source, followed by swelling of the precursor and then pillaring or delamination of the swollen materials) making them costlier to implement.

The innovative method uses seeded growth for synthesis of Zeolite, OSDAs are not required during the secondary growth of zeolite nanosheets.

The present invention discloses a bottom-up seeded hydrothermal growth method of forming zeolite nanosheets. The nanosheets formed, exhibited increased lateral dimensions and at higher yield, compared to the top-down, exfoliation-based, approaches.

Mixing the pretreated mine tailings with an alkali solution and then hydrothermal treatment of the alkali solution and mine tailings mixture is filtered out and after drying for hours zeolite has been synthesized in crystal form as mentioned in FIG. 2.

Here, the hydrothermal synthesis of zeolite satisfies the requirements of green synthesis or zero emission waste.

An embodiment explains, the synthesized Zeolite nanosheet has high purity and precise pore structure with an estimated cost reduction of ten times compared with conventional methods.

This method is also beneficial to the environment by reducing mining waste that causes detrimental effects on the environment.

As per an embodiment, raw materials for Zeolite synthesis have been taken from mining waste/mine tailing as shown in FIG. 3.

Pretreatment of the raw materials (mine tailings) have been performed to remove any impurities therein to obtain silica source that is >99.8% pure from the feedstock.

As per an embodiment, Zeolites disclosed in the present invention, have molecular pillars. The construction of molecular pillars in layered materials (see FIG. 4) while preserving the three-dimensional crystallinity enables the creation of porous structures with a narrow pore-size distribution.

The top layered material 401, and the bottom layered material 403. In between molecular pillars 402 are constructed without the use of pillaring agents. This method opens up a route to prepare composite materials with unusual combinations of properties.

The zeolite nanosheets obtained through the current invention have the same purity levels as those synthesized zeolites nanosheets using conventional techniques. Large scale zeolite nanosheet membranes with novel lamellar structure as shown in FIG. 5 produced by the current invention gives the resultant material precise pore structure with high flux and high selectivity without any cracks and other non-selective defects.

The invention also explains direct (bottom-up) synthesis of Zeolite could produce high aspect-ratio zeolite nanosheets, with improved yield at lower cost.

Here there are two crystal structures with different symmetry forming single unit cell level; higher symmetry structure acts as a linker to connect single-unit-cell elements of the lower symmetry structure causing branching of the latter and a rotational intergrowth or twinning.

Nanocrystal-seeded growth method may be triggered by rotational intergrowth to synthesize high-aspect-ratio MFI nanosheets with a thickness of 5 nanometres (2.5 unit cells) as shown in FIG. 6.

These high-aspect-ratio nanosheets allow the fabrication of thin and defect-free coatings that effectively cover porous substrates. These coatings can be intergrown to conform to self-pillorised (“house-of-cards”) architecture to produce high-flux and ultra-selective membranes.

A method of synthesis of zeolite nanosheet from mining waste, said method comprising the steps of: removing impurities by pretreatment of mine tailing to obtain silica; mixing the pretreated mine tailings with an alkali solution having water as solvent, wherein molar ratios of silicon dioxide (SiO2), tetrapropylammonium hydroxide (TPAOH), sodium hydroxide (NaOH) and hydrogen dioxide (H2O) is varied based on whether zeolites are to be synthesized or all-silica zeolite are to be synthesized; mixing alkali hydroxide solution, and heating in teflon lined stainless steel autoclave with different thermal profiles depending on whether zeolites are synthesized or all-silica zeolites are synthesized; and isolating, and drying synthesized zeolites, wherein drying time and calcination thermal profile is selected based on whether zeolites are synthesized or all-silica zeolite are synthesized; and sintering mixture of silica and polymer that is formed into a desired shape to form a silica support; and depositing zeolite seeds having a predefined lamellar structure on the silica support to form the seed layer, and a film is formed by secondary growth of the lamellar structure of the zeolite membrane is thus formed.

The method as claimed in claim 1, wherein the alkali hydroxide solution is heated until the pH of the solution is less than or equal to 9. The method as claimed in claim 1, wherein the different thermal profile comprises pre-heating, baking, and cooling. The method as claimed in claim 1, wherein the alkali hydroxide comprises NaOH or potassium hydroxide (KOH). The method as claimed in claim 1, wherein silica powder is grinded to a fine powder and then mixed with a polymer to form a mixture.

The method as claimed in claim 1, wherein the zeolite nanosheet structure is self-pillared, such that the self-pillared zeolites are porous in nature. The method as claimed in claim 1, wherein the lamellae structure is in houses of cards arrangement. The method as claimed in claim 1, wherein concentration of the alkali solution is up to 85%.

The method as claimed in claim 8, wherein the alkali solution comprises 80Si:20KOH:9500H2O. The method as claimed in claim 1, wherein reaction temperature is at least 140° C. The method as claimed in claim 1, wherein the method comprises stirring, and wherein stirring technique is selected from a group consisting of mechanical stirring such as propeller stirring, turbulent flow, ultrasonic stirring, or stirring based on microwave vibration.

A zeolite nanosheet comprising: a silica support structure; and a lamellar zeolite membrane having molecular pillaring coated over the silica support structure, wherein the zeolite nanosheet enables adsorption or desorption of gaseous material having big or small molecular size.

The zeolite nanosheet as claimed in claim 12, wherein the pore diameter ranges from 6-12 Å. The zeolite nanosheet as claimed in claim 12, wherein thickness of the zeolite nanosheet is up to 5 nanometers. The zeolite nanosheet as claimed in claim 12, wherein the zeolite nanosheet is organic structure-directing agent (OSDA) free. The zeolite nanosheet as claimed in claim 12, wherein molecular sieving and selectivity of the zeolite nanosheet is high due to the presence of mesopores.

### BRIEF DESCRIPTION OF THE ACCOMPANYING DRAWINGS

A clear understanding of the key features of the invention summarized below may be had by reference to the appended drawings, which illustrate the Zeolite nanosheet synthesis and method of preparation thereof, although it will be understood that such drawings depict preferred embodiments herein and, therefore, are not to be considered as limiting its scope with regard to other embodiments which the invention is capable of contemplating. Accordingly:

FIG. 1 illustrates the conventional steps of producing zeolite membrane from minerals as per an embodiment herein.

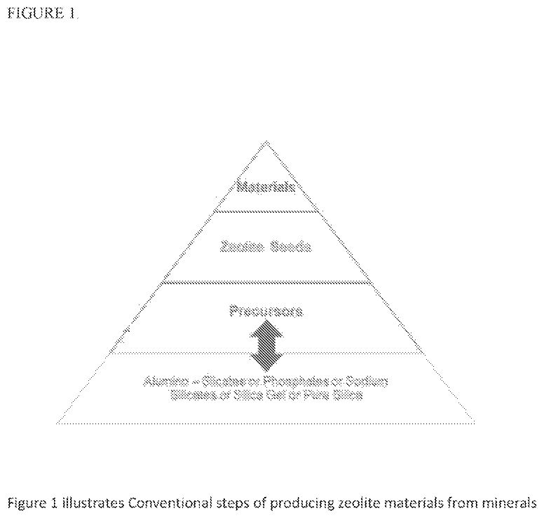

FIG. 2 illustrates the method of Zeolite nanosheet synthesis as per an embodiment herein.

FIG. 3 illustrates the pretreatment of the raw materials (mine tailings) from feedstock, using an exemplary mining site, as per an embodiment herein.

FIG. 4 illustrates the production of a porous crystalline Zeolite and formation of molecular pillaring in Zeolite nanosheet (lamellar structural) without the introduction of a pillaring agent as per an embodiment herein.

FIG. 5 illustrates the synthesis of OSDA-free zeolite membrane and adsorption of gasses as per an embodiment herein.

FIG. 6 illustrates the composition and properties of Zeolite Nanosheet as per an embodiment herein.

It should be appreciated by those skilled in the art that any diagrams herein represent conceptual views of illustrative systems embodying the principles of the present subject matter.

### DETAILED DESCRIPTION OF THE INVENTION

The present invention discloses the Synthesis of Zeolite nanosheets from mining waste without using any OSDA or chemical reagents during the secondary growth of zeolite nanosheets.

The produced Zeolite nanosheet may be a synthetic material. Further the invention utilizes bottom-up synthesis strategies for producing organic template free zeolites.

The present invention in an embodiment also explains a synthesized Zeolite nanosheet that has high purity and precise pore structure with the high flux and high selectivity without any cracks and other non-selective defects in synthesized Zeolite nanosheet.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefits and each can also be used in conjunction with one or more, or in some cases all, of the other disclosed techniques. Accordingly, for the sake of clarity, this description will refrain from repeating every possible combination of the individual steps in an unnecessary fashion.

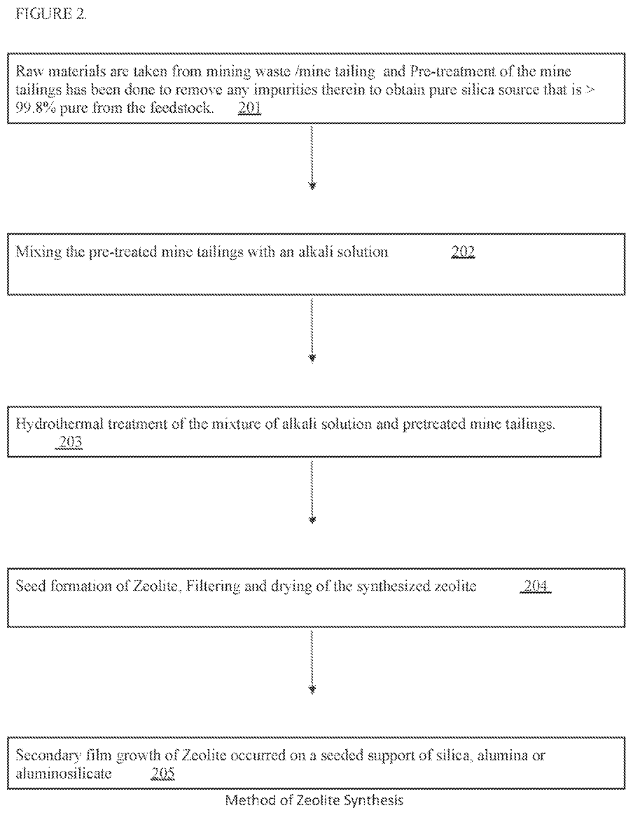

FIG. 2 is a flowchart that illustrates the method of Zeolite nanosheet synthesis from mine tailings/mining waste according to an embodiment herein.

At step 201, raw materials are taken from mining waste/mine tailing and pretreatment of the raw materials (mine tailings) to remove any impurities therein to obtain silica source that is >99.8% pure from the feedstock.

At step 202, the pretreated mine tailings with an alkali solution are mixed.

At step 203, hydrothermal treatment of the mixture of alkali solution and pretreated mine tailings has been performed.

At step 204 Zeolite Seed is formed and then synthesized zeolite is filtered out and dried to get a crystalline form of Zeolite.

At step 205, secondary film growth of Zeolite occurred on a seeded support of silica, alumina or aluminosilicate.

As per an embodiment, according to step (1) as 201 comprises at least one source for X2O3, the YO2:X2O3 molar ratio of the mixture has value >500.

Further, the mine tailings contain at least one source for YO2, at least one source for X2O3, wherein Y is a tetravalent element, and X is a trivalent element.

Further, preferred tetravalent elements include Si, Sn, Ti, Zr, and Ge, and combinations thereof. More preferably, Y stands for Al, Ti, or Zr, and/or Sn or any combination of said trivalent elements.

The molar ratio of X/Y determines important chemical and physical characteristics for catalysis and separation applications.

Furthermore, zeolites are classified as Zeolites with a molar ratio of X/Y<500 and all-silica zeolites with a molar ratio X/Y>500 (some examples of this material may include Zeosil®).

The methods and processes described in this invention apply to Zeolites as well as all-silica zeolite.

Further in an embodiment, the zeolitic material structure further comprises X2O3, wherein X stands for any conceivable trivalent element, X standing for either one or several trivalent elements.

Preferred tetravalent elements include Al, B, In, and Ga, and combinations thereof.

As per an embodiment of the inventive process wherein the alkali solution according to step 202 comprises: a) alkali metal M, preferably sodium (Na) and/or potassium(K). In general, the alkali metal M can be contained in the mixture in any conceivable amount; b) one or more sources for hydroxide anions OH—.

In general any conceivable source for OH— can be used, wherein the at least one source preferably comprises a metal hydroxide in the following preferable order-a hydroxide of an alkali metal M or sodium and/or potassium hydroxide or sodium hydroxide.

In general the OH—:YO2 molar ratio of the mixture according to step 201 of the inventive process can have any conceivable value.

As per an embodiment of the present invention, further the mixture according to step 202 of the inventive process comprises a solvent.

Preferably, the solvent comprises water, wherein the molar ratios of SiO2, TPAOH, NaOH and H2O is varied depending on whether zeolites are to be synthesized or all-silica zeolite are to be synthesized.

As per an embodiment of the present invention 203 the resultant filtered mixture is then mixed with alkali hydroxide (NaOH or KOH) solution and heated in teflon lined stainless steel autoclave with different thermal profiles (pre-heating, baking, cooling) depending on whether zeolites are synthesized or all-silica zeolite are synthesized. The solution is heated until the pH of the solution is lower than 9.

In one embodiment of the invention according to step 204, Zeolite seeds are isolated. These isolated seeds are having predefined lamellar structure.

The lamellar zeolite crystal seeds obtained from this novel process with the use of a cheap alkali metal hydroxide instead of the organic structure derivative.

Finally the synthesized Zeolite is then thoroughly washed with distilled water, and then dried and calcined.

The drying time and calcination thermal profile is selected based on whether zeolites are synthesized or all-silica zeolite are synthesized.

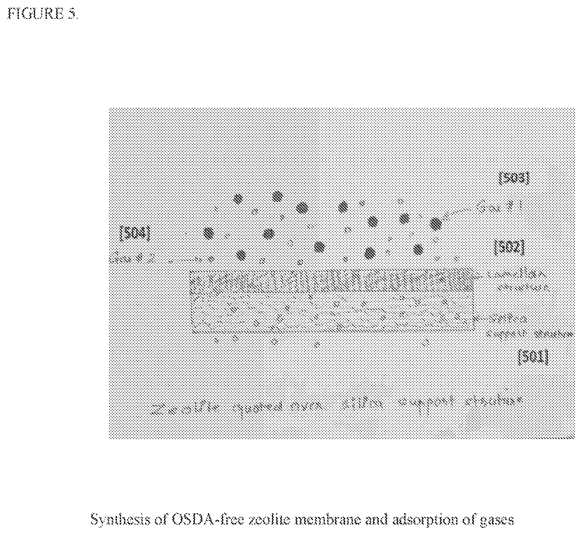

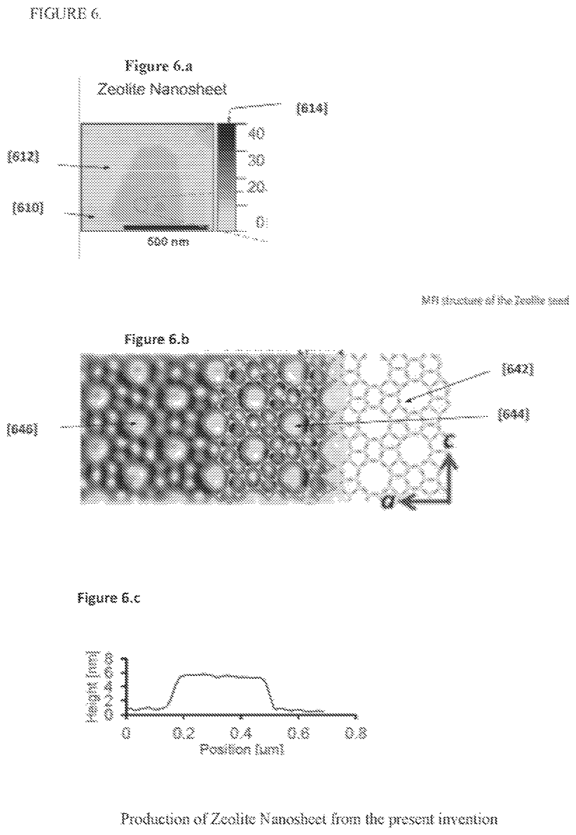

The method could be extended to forming Zeolite films with lamellar structure (Refer to FIGS. 5, 6).

As per an embodiment the method of making the silicon support structure and the method of deposition or coating of the lamellar zeolite on the silicon support structure is discussed herewith as mentioned in step 205. Silica powder is grinded to a fine powder and then mixed with a polymer to form a mixture.

The mixture of silica and polymer is formed into a desired shape and finally the resultant shaped mixture is sintered to form a silica support.

Here by depositing Zeolite seeds having a predefined lamellar structure on the silica support to form a seed layer; and film is formed by secondary growth or secondary growth as the lamellar structure of the zeolite membrane is formed.

Use of inexpensive inorganic alkali acids (KOH or NaOH) and mining wastes as raw material source of silicon and alumina was limited to precursor solution to form seeds of Zeolite crystals.

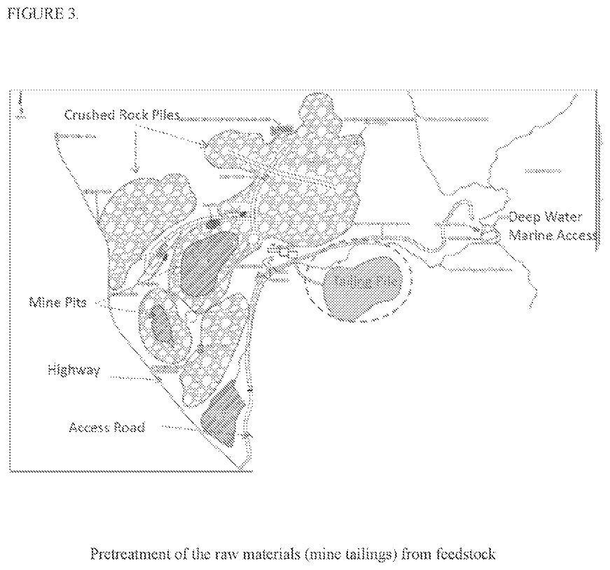

FIG. 3 illustrates the pretreatment of the raw materials (mine tailings) from feedstock, using an exemplary mining site, as per an embodiment herein.

Here silicon-containing waste and aluminum-containing waste are used as reaction raw materials. It is necessary to conduct a preliminary treatment in advance.

When these materials are dried, crushed and grinded into a particle size of up to 20 μm, or preferably, up to 5 μm so as to achieve easier mixing with the aqueous alkali solution.

It is necessary to convert dehydrated cakes into slurry or solution in an aqueous alkali solution. After forming a liquid slurry solution in which those solid impurities are not participating in the reaction must be removed through filtration.

FIG. 3 illustrates an example mining site. The tailing pond accumulates the mine tailings rich in silicon-containing waste.

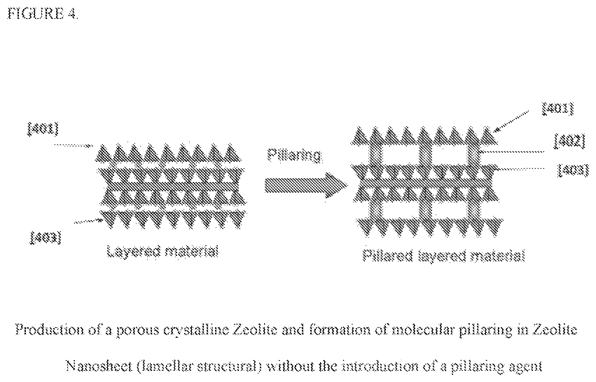

FIG. 4 illustrates the formation of molecular pillars without the use of pillaring agents as per an embodiment herein.

The top layered material is 401 and the bottom layered material is 403. In between molecular pillars 402 are constructed without the use of pillaring agents and “house of cards’ arrangement appears.

The construction of molecular pillars in layered materials preserves the three-dimensional crystallinity without using OSDA and enables the creation of porous structures with a narrow pore-size distribution.

This method opens up a route to prepare composite materials with unusual combinations of properties. The arrangement of the lamellae shows “house of cards’ arrangement in between 401 and the lamellae, creating a self-pillared Zeolite nanosheet.

These self-pillared Zeolites are porous in nature. Here, these crystalline nanoparticles show twin intergrowth mechanisms. This mechanism is responsible for the formation of the type of self-pillared (house-of-cards) layered Zeolite material.

FIG. 5 illustrates the method of forming lamellar coated zeolite membrane or Synthesis of OSDA-free zeolite membrane on a support structure as per an embodiment herein.

The support structure is made up of silica. Silica support structure is shown as 501. Then zeolite is coated on top of the Silica support structure.

The coating of Zeolite on a support forms a membrane with lamellar structure. This Zeolite lamellar structure is shown as 502.

Here Zeolite Nanosheet has been formed. This zeolite membrane with lamellar structure is useful in adsorbing gasses. Big gas (Gas #1) molecules are shown as 503 and small gas (Gas #2) molecules are shown as 504.

In addition, zeolite membranes can be synthesized without the use of organic structure derivatives. Formation of the lamellar structure depends upon various synthesis conditions and optimum synthesis conditions, reaction time, which are described below in detail.

The resultant zeolite membranes without organic structural derivatives synthesized under optimal conditions have the same purity and pore structure similar to conventional membranes.

The novel lamellar zeolite membrane with molecular pillaring coated over silica support of the present invention has good gas adsorption/desorption capabilities.

FIG. 6 illustrates the Zeolite nanosheets having lamellar structure with high flux and high selectivity as per an embodiment herein.

Here nanocrystal-seeded growth method may be triggered by a single rotational intergrowth to synthesize high-aspect-ratio MFI nanosheets with a thickness of 5 nanometres (2.5 unit cells).

These high-aspect-ratio nanosheets allow the fabrication of thin and defect-free coatings that effectively cover porous substrates. These coatings can be intergrown to produce high-flux and ultra-selective membranes.

As per an embodiment herein FIG. 6a shows AFM (Atomic Force Microscopy) height image with a height profile along the indicated trace, after seed removal by mechanical rubbing.

As per an embodiment herein FIG. 6.b shows the the HR-TEM (High-Resolution Transmission Electron Microscopy) images overlaid with the crystal structure model along [100], [010] and [001] zone axis, confirming the MFI-type zeolite structure [The MFI (Mobil-type five) zeolite structure] of the seed nanocrystal.

This is of a portion zoomed in from the FIG. 6. a. A person skilled in the art may realize that the FIG. 6.b represents different sections of the seed nanocrystal. 642 being a model of the MFI structure along the b-axis. 644 being the image of an MFI nanocrystal along b-axis. 646 being the image of another MFI nanocrystal along b-axis. They consist of silicon atoms and oxygen atoms being represented. The HR-TEM images of the section are overlaid on the molecular structure.

As per an embodiment herein, FIG. 6c shows a height profile extracted along the white line 612 in the FIG. (6a). The disclosure also explains the reaction conditions in the manufacturing of zeolite nanosheets and the influence of synthesis parameters on crystallinity.

The resultant zeolite nanosheet manufactured from the present invention has a novel lamellar structure with high flux and high selectivity.

The main factors of reaction conditions in the manufacture of zeolite in the present invention include: a) concentration of the aqueous alkali solution; b) solid raw materials/liquid raw materials ratio of the aluminum source and the silicon source; c) reaction temperature and pressure; d) reaction time; and e) stirring effect.

Crystallization rate is promoted by introducing gel aging, seeding, stirring, and rapid heating rate. The crystal size could be decreased significantly by stirring the gel during the synthesis or subjecting the substrate mixture to an aging treatment at room temperature.

As per an embodiment, the concentration of the aqueous alkali solution should appropriately be 85%. In one embodiment, the ratio of the solid raw materials and/or the liquid raw materials of the silicon source to the aqueous alkali solution may preferably be such that 80 Si:20 KOH:9500 H2O.

A reaction temperature is appropriately selected in response to the kind of zeolite to be manufactured as shown in FIG. 2.

A commonly applicable temperature should preferably be at least 140° C. The reaction is carried out usually under atmospheric pressure.

At a high reaction temperature, a pressure tight reactor is necessary, and the reaction proceeds under an applied pressure.

As per an embodiment herein, the reaction time is a period of time, is necessary to obtain seed growth of zeolite film as shown in FIG. 6, and largely affected by the other factors. For example, temperature, pressure, and stirring conditions exert an important effect on the reaction time.

It is necessary to provide a reaction time of from several tens of minutes to several hours, or in some cases, even about a day.

As per an embodiment, the stirring effect also has an important effect on solubility of solid constituents through effective attack by the OH group in the aqueous alkali solution particularly to the solid raw materials.

More specifically, mechanical stirring such as propeller stirring, turbulent flow, ultrasonic stirring, or stirring based on microwave vibration is suitably adopted.

By means of such stirring, it is possible to further improve chances of contact between solid materials and crystal minerals in the attack to the solid materials by the aqueous alkali solution, thus permitting further promotion of the zeolite cell generating reaction. Stirring is effective even when using liquid raw materials.

As per an embodiment of the present invention the synthesized Zeolite nanosheet has more industrial applicability because the molecular sieving and selectivity of the zeolite synthesized from the present invention is high due to the presence of mesopores (see FIG. 5).

The lamellar Zeolite mesopores, which allow for fast transport of bulky molecules and thereby enable improved performance in petrochemical and biomass processing. The lamellar Zeolite nanosheet material can be used for separation processes such as ethanol/butanol from water, carbon dioxide from methane and linear hydrocarbons from branched hydrocarbons and acts as a gas adsorbent for air purification systems to lower emission of CO2 effectively.

As per an embodiment, the invention utilizes mining tailings as raw material instead of natural sources which has been conventionally used, is reacted with an alkali solution such as NaOH, or subjected to hydrothermal synthesis to synthesize zeolite satisfies the requirements of green synthesis or zero emission waste (See FIG. 2).

Also, the zeolite nanosheets produced using the present invention do not contain any “organic SDA” such as tetraethylammonium ions which are very expensive, therefore the present method is very economical with an estimated cost reduction of ten times compared with conventional fabrication methods.

As per an embodiment of the present invention, the zeolite nanosheet obtained through the current invention has the competing purity levels as those synthesized using conventional techniques.

Large scale zeolite nanosheet with novel lamellar structure produced by the current invention gives the resultant material precise pore structure with high flux and high selectivity without any cracks and other non-selective defects.

I/We claim:

1. A method of synthesis of zeolite nanosheet from mining waste, said method comprising the steps of:
a. removing impurities by pretreatment of mine tailing to obtain silica;
b. mixing the pretreated mine tailings with an alkali solution having water as solvent, wherein molar ratios of silicon dioxide (SiO2), tetrapropylammonium hydroxide (TPAOH), sodium hydroxide (NaOH) and hydrogen dioxide (H2O) is varied based on whether zeolites are to be synthesized or all-silica zeolite are to be synthesized;
c. mixing alkali hydroxide solution, and heating in teflon lined stainless steel autoclave with different thermal profiles depending on whether zeolites are synthesized or all-silica zeolite are synthesized;
d. isolating, and drying synthesized zeolites, wherein drying time and calcination thermal profile is selected based on whether zeolites are synthesized or all-silica zeolites are synthesized;
e. sintering mixture of silica and polymer that is formed into a desired shape to form a silica support; and
f. depositing zeolite seeds having a predefined lamellar structure on the silica support to form the seed layer, and a film is formed by secondary growth of the lamellar structure of the zeolite membrane is thus formed.

2. The method as claimed in claim 1, wherein the alkali hydroxide solution is heated until the pH of the solution is less than or equal to 9.

3. The method as claimed in claim 1, wherein the different thermal profile comprises pre-heating, baking, and cooling.

4. The method as claimed in claim 1, wherein the alkali hydroxide comprises NaOH or potassium hydroxide (KOH).

5. The method as claimed in claim 1, wherein silica powder is grinded to a fine powder and then mixed with a polymer to form a mixture.

6. The method as claimed in claim 1, wherein the zeolite nanosheet structure is self-pillared, such that the self-pillared zeolites are porous in nature.

7. The method as claimed in claim 1, wherein the lamellae structure is in houses of cards arrangement.

8. The method as claimed in claim 1, wherein concentration of the alkali solution is up to 85%.

9. The method as claimed in claim 8, wherein the alkali solution comprises 80Si:20KOH:9500H2O.

10. The method as claimed in claim 1, wherein reaction temperature is at least 140° C.

11. The method as claimed in claim 1, wherein the method comprises stirring, and wherein stirring technique is selected from a group consisting of mechanical stirring such as propeller stirring, turbulent flow, ultrasonic stirring, or stirring based on microwave vibration.

12. A zeolite nanosheet comprising:
a. a silica support structure; and
b. a lamellar zeolite membrane having molecular pillaring coated over the silica support structure,
wherein the zeolite nanosheet enables adsorption or desorption of gaseous material having big or small molecular size.

13. The zeolite nanosheet as claimed in claim 12, wherein the pore size ranges from 6-12 Å.

14. The zeolite nanosheet as claimed in claim 12, wherein thickness of the zeolite nanosheet is up to 5 nanometers.

15. The zeolite nanosheet as claimed in claim 12, wherein the zeolite nanosheet is organic structure-directing agent (OSDA) free.

16. The zeolite nanosheet as claimed in claim 12, wherein molecular sieving and selectivity of the zeolite nanosheet is high due to the presence of mesopores.
